(19) United States
(12) Patent Application Publication
(10) Pub. No.: US 2011/0290555 A1
(43) Pub. Date: Dec. 1, 2011

(54) CABLE HARNESS

(75) Inventors: Detian HUANG, Hitachi (JP); Takanobu WATANABE, Hitachi (JP); Noriyuki IMAI, Hitachi (JP); Hiroshi KOMURO, Hitachi (JP); Kazushige NAGANO, Hitachi (JP)

(73) Assignee: HITACHI CABLE FINE-TECH, LTD., Ibaraki (JP)

(21) Appl. No.: 12/981,955

(22) Filed: Dec. 30, 2010

(30) Foreign Application Priority Data
May 31, 2010 (JP) 2010-124789

(51) Int. Cl. H02G 3/00

(52) U.S. Cl. 174/70 R

(57) ABSTRACT

A cable harness has a cable main body including a wire group made of a plurality of electric wires and a braid sleeve collectively covering an outer periphery of the wire group, and connecting terminals connected to both ends of the cable main body. The braid sleeve is formed by braiding wires for braiding. Each of the wires for braiding has a high tension member having an indentation recovery coefficient of 90% or more and a metal strip wound around a surface of the high tension member. The wire has an indentation recovery coefficient of 80% or more.

The present application is based on Japanese Patent Application No. 2010-124789 filed on May 31, 2010, the entire contents of which are incorporated herein by reference.

### BACKGROUND OF THE INVENTION

1. Field of the Invention

The present invention relates to a cable harness to be used for a movable part of a data communication electronic equipment (electronic device) such as portable phone, laptop computer, and compact video camera.

2. Prior Art

In the electronic devices such as mobile phone, laptop computer, compact video camera, and portable data communication terminal (PDA: Personal Digital Assistant), a connecting part for connecting a main body for operating the electronic device and a display part such as liquid crystal display is often configured to have a foldable structure (openable and closable type structure). In the connecting part having the aforementioned structure, as a wiring material for signal transmission for connecting the main body and the display part, a flexible printed circuit (FPC) has been often used, since the FPC is relatively flexible and can be disposed within a flat and thin type electronic device.

On the other hand, in the electronic devices recently used, the main body and the display part are often configured to be connected to each other in a rotatable manner or twistable manner. Further, it is required to suppress electromagnetic interference (EMI) between circuits due to electromagnetic wave radiated from a signal line.

Japanese Patent Laid-Open No. 2006-24372 (JP-A 2006-24372) proposes a cable harness as the wiring material to be used for the movable part suitable for rotation or twisting. The cable harness disclosed by JP-A 2006-24372 comprises a plurality of small diameter electric wires (e.g. ultrafine coaxial cables), a plurality of tinsel-coppers each of which comprises a high tension fiber and a copper foil tape wrapped around a surface of the high tension fiber, and a braid sleeve covering the electric wires.

JP-A 2006-24372 describes that impedance matching and EMI characteristics can be provided by the electric wires, and a ground potential difference at both ends of an outer conductor of the electric wires can be reduced without bending and twisting properties since the tinsel coppers are provided in parallel with the electric wires.

### SUMMARY OF THE INVENTION

As described above, the electronic devices recently used are often configured in such a manner that the display part is slidable with respect to the main body. Therefore, as to the wiring material to be installed in the electronic device having a slidable configuration, the wiring material is configured to operate while sliding and bending between the display part and the main body. Further, in the electronic devices recently used, a further reduction in thickness of the device is rapidly demanded, so that it is required to reduce a thickness of a wiring space of the wiring material to be installed between the display part and the main body. Therefore, the wiring material is used in a severe environment of use, in which the wiring material is disposed in a wiring space with a height less than about 3.0 mm, and the wiring material operates with bending and sliding in the wiring space within the aforementioned height range, when the electronic device is in operation.

However, in the conventional cable harness, the operation which involves bending and sliding has not been considered. Therefore, a part covered by the braid sleeve is weak in straight advancing property, and a resistance property against the operation which involves sliding is not sufficient. Therefore, it is difficult to use the conventional cable harness as the wiring material which operates while sliding in the wiring space within the aforementioned height range. Even if the wiring material is installed in the wiring space, the operation which involves sliding cannot be smoothly carried out.

Accordingly, an object of the present invention is to provide a cable harness, which can be installed in a very narrow wiring space, and has excellent resistance property against the operation which involves sliding.

According to a feature of the present invention, a cable harness comprises:

a cable main body comprising a wire group comprising a plurality of electric wires and a braid sleeve collectively covering an outer periphery of the wire group, the braid sleeve comprising braided wires, each of the wires comprising a high tension member having an indentation recovery coefficient of 90% or more and a metal strip wound around a surface of the high tension member; and

connecting terminals connected to both ends of the cable main body.

The wire preferably has an indentation recovery coefficient of 80% or more.

The indentation recovery coefficient of the high tension member may be defined as a ratio of an indentation recovery length to an initial length when an indentation for an indentation length is carried out, where the initial length is a distance between a fixed end and a movable end of the high tension member before indentation, the indentation length is a predetermined value, and the indentation recovery length is a distance between the fixed end and the movable end after release of the indentation.

The metal strip is preferably spirally wound around the surface of the high tension member by abutting wrapping.

The high tension member preferably comprises a PET having a tensile strength of 700 MPa or more and the metal strip preferably comprises a copper alloy having a tensile strength of 700 MPa or more.

A surface of the metal strip may be plated with Sn-plating.

The high tension member may comprise a single fiber.

The metal strip may comprise a copper alloy strip formed by rolling or drawing a linear-shaped copper alloy wire.

The metal strip preferably comprises the copper alloy strip having a first tensile strength after the rolling being greater than a second tensile strength before the rolling.

The metal strip preferably comprises the copper alloy strip having a first break elongation after the rolling being greater than a second break elongation before the rolling.

A ratio of a difference between the first break elongation and the second break elongation with respect to the second break elongation is preferably 10% or more and 60% or less.

### ADVANTAGES OF THE INVENTION

According to the invention, it is possible to provide a cable harness, which can be installed in a very narrow wiring space, and has excellent resistance property against the operation which involves sliding.

### BRIEF DESCRIPTION OF DRAWINGS

Next, embodiments according to the invention will be explained in conjunction with appended drawings, wherein:

FIG. 1 is a side view of a cable harness in an embodiment according to the present invention;

FIG. 2 is an enlarged side view of a braid sleeve of the cable harness of FIG. 1 in the embodiment according to the present invention;

FIG. 3 is an enlarged side view of a wire for braiding composing the braid sleeve of the cable harness of FIG. 1 in the embodiment according to the present invention;

FIG. 4 is an explanatory diagram showing a method for measuring an indentation recovery coefficient; and

FIG. 5 is an explanatory diagram showing a slide test method for comparing Examples 1 and 2 with a comparative example 1.

### DETAILED DESCRIPTION OF THE PREFERRED EMBODIMENT

Next, the embodiment according to the present invention will be explained in more detail in conjunction with the appended drawings.

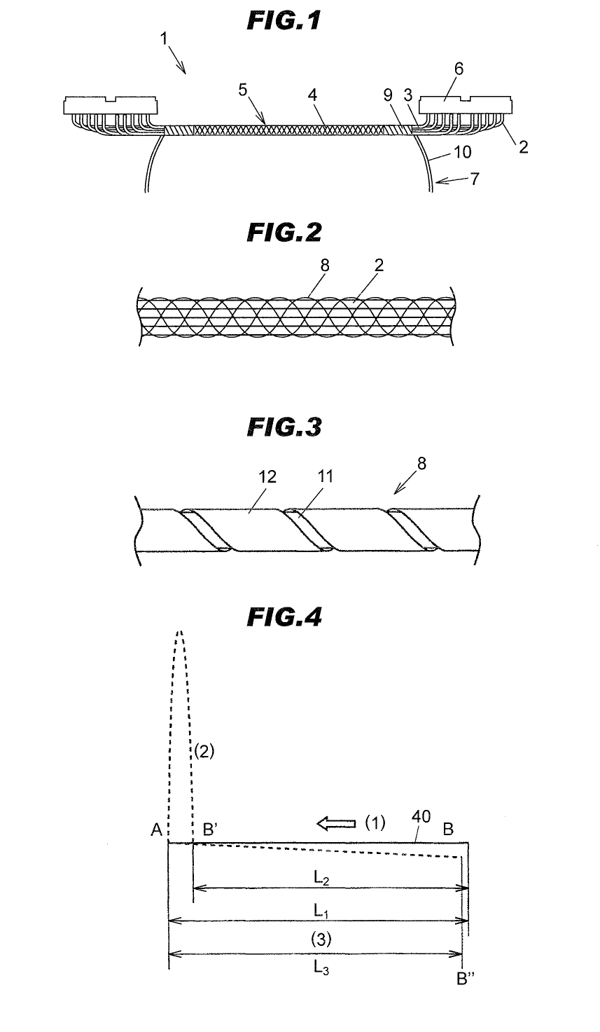

FIG. 1 is a side view of a cable harness in an embodiment according to the present invention.

### (Total Structure of Cable Harness 1)

Referring to FIG. 1, the cable harness 1 in the embodiment comprises a cable main body 5 comprising a wire group 3 comprising plural electric wires 2 and a braid sleeve 4 collectively covering an outer periphery of the wire group 3, and connector terminals 6 connected to both ends of the cable main body 5. Further, ground connecting parts 7 are fixed to both ends of the braid sleeve 4, respectively. The ground connecting parts 7 are configured to be electrically connected to a ground part of an electronic device.

In other words, the cable main body 5 comprises the wire group 3 comprising a plurality of electric wires 2 and the braid sleeve 4 collectively covering the outer periphery of the wire group 3, the braid sleeve 4 comprises braided wires 8, each of the wires 8 comprises a high tension member 11 having an indentation recovery coefficient of 90% or more and a metal strip 12 wound around a surface of the high tension member 11; and connector terminals 6 connected to both ends of the cable main body 5.

As for the electric wires 2 used for the wire group 3, following cables may be used. For example, a coaxial cable comprising an insulated wire including a center (inner) conductor covered with an insulative coating around its outer periphery, an outer conductor, and a jacket (insulator) may be used. Further, a four-conductor diagonal coaxial cable (so-called “Quad-X cable”, “Quadrax cable”, ‘Quad cable”, or the like) for LVDS (Low Voltage Differential Signaling) using the aforementioned coaxial cables may be used. Also, a two-conductor parallel cable (so-called “Twinax cable”), or a twisted-pair cable may be used. A plurality of any one kind of the aforementioned wires and cables may be collectively used. Alternatively, a plurality of single kind of the aforementioned wires or a plurality of at least two or more kinds of the aforementioned wires may be used collectively. When using the wire group 3 composed of the insulated wires, only the both terminals of the braid sleeve 4 are electrically connected to the ground parts of the equipment.

### (Braid Sleeve 4)

FIG. 2 is an enlarged side view of a braid sleeve of the cable harness of FIG. 1 in the embodiment according to the present invention. The braid sleeve 4 is formed by braiding conductive wires 8 for braiding, and wrapped by an adhesive tape 9 at the ends thereof and is fixed to the wire group 3. The adhesive tape 9 is a fixing member for preventing the braid sleeve 4 from raveling.

Referring to FIG. 2, the plurality of wires 8 for braiding are used for the braid sleeve 4. The braid sleeve 4 with a tubular shape is formed by braiding the wires 8 for braiding in such a manner that the wires 8 for braiding are wound (wrapped) around the wire group 3 to cross each other with a predetermined spiral diameter at a predetermined braid (spiral) pitch. In other words, the braid sleeve 4 comprises braided wires 8. It is also possible to insert the wire group 3 into the braid sleeve 4 after forming the braid sleeve 4 by braiding the wires 8 for braiding.

At each of the ground connecting parts 7, an extension 10 of the wire 8 for braiding is provided. The extensions 10 are extended outwardly (toward the connector terminals 6) in the right and left directions with respect to the end parts of the braid sleeve 4 wrapped by the adhesive tape 9 such that the ground connecting parts 7 can be easily connected electrically to a ground part of the equipment (not shown) having a movable part which operates while sliding.

### (Arrangement of the Cable Harness 1)

In the cable harness 1 shown in FIG. 1, a connecting direction of the connector terminals 6 provided at the both ends of the cable main body 5 of the cable harness 1 is arranged vertically to a longitudinal direction of the cable main body 5. Respective electric wires 2 composing the wire group 3 are extended horizontally in the left or right direction from the distal end of the part wrapped by the adhesive tape 9. The electric wires 2 are separated at positions corresponding to the respective connector pins in each of the connector terminals 6. Then, the electric wires 2 are bent toward the connector terminal 6 (upwardly in FIG. 1), namely substantially vertically to the extended line of the wire group 3, and extended straightly to the respective poles (connector pins) of each of the connector terminals 6.

FIG. 3 is an enlarged side view of a wire 8 composing the braid sleeve 4 of the cable harness 1 of FIG. 1 in the embodiment according to the present invention.

Referring to FIG. 3, in the cable harness 1, the braid sleeve 4 is formed by braiding the wires 8 for braiding. Each wire 8 for braiding comprises a high tension member 11 having an indentation recovery coefficient of 90% or more and a metal strip 12 wound (wrapped) around a surface of the high tension member 11 by abutting wrapping. In particular, it is preferable that the wire 8 used for the braid sleeve 4 has an indentation recovery coefficient of 80% or more.

Herein, the indentation recovery coefficient of the wire 8 may be changed by appropriately adjusting several factors, e.g. a method of winding the metal strip 12 around the surface of the high tension member 11, a winding pitch therefor, and a winding thickness thereof

### (Indentation Recovery Coefficient)

Next, an example of methods for measuring an indentation recovery coefficient of the high tensions member 11 will be explained below.

FIG. 4 is an explanatory diagram showing a method for measuring the indentation recovery coefficient. Herein, the indentation recovery coefficient is one of parameters showing elastic properties of the material.

Referring to FIG. 4, the indentation recover coefficient is measured as follows.

At a first step (1), a high tension member 40 having an initial length L₁ (mm) (i.e a distance AB between a point A and a point B) is disposed straightly. One end (at the point A) of the high tension member 40 is fixed.

At a second step (2), another end (at the point B) of the high tension member 40 is moved and indented until a point B′ for an indentation length L₂ (mm) (L₂ mm=0.9×L₁ mm) toward the point A. Thereafter, the indentation of another end (at the point B′) of the high tension member 40 is released while one end (at the point A) of the high tension member 40 is fixed.

At a third step (3), a straight distance AB″ between one end (at the point A) of the high tension member 40 and another end (the point B″) of the high tension member 40 which is pushed back by its elasticity due to release of the indentation is measured as an indentation recovery length L₃ (mm). A ratio of the indentation recovery length L₃ (the distance AB″) to the initial length L₁ (the distance AB) is defined as an indentation recovery coefficient of the high tension member 40.

The indentation recovery coefficient of the wire 8 for braiding is measured similarly to a method for measuring the indentation recovery coefficient of the high tension member 40.

In other words, the indentation recovery coefficient of the high tension member 40 is defined as a ratio of the indentation recovery length L₃ to the initial length L₁ when the indentation for an indentation length L₂ is carried out, in which the initial length L₁ is a distance between a fixed end and a movable end of the high tension member 40 before indentation, the indentation length L₂ is a predetermined value, and the indentation recovery length L₃ is a distance between the fixed end and the movable end after release of the indentation.

The high tension member 11 may be composed of a single fiber. Alternatively, the high tension member 11 may comprise a multi-strand fiber comprising plural fibers that are stranded together. When comparing the multi-strand high tension member and a single-fiber high tension member, the multi-strand high tension member is softer than the single-fiber high tension member. Accordingly, so as to obtain the indentation recovery coefficient of 90% or more, an outer diameter of the multi-strand high tension member should be greater than an outer diameter of the single-fiber high tension member 11. Further, the high tension member comprising a multi-strand fiber comprising plural fibers stranded together has an appearance with a surface irregularity compared with the single-fiber high tension member 11. Therefore, if the metal strip 12 is wrapped around the surface of the multi-strand high tension member, the metal strip 12 will have a surface irregularity. In such a case, when the cable harness 1 is bent, irregular surfaces of the metal strip 12 are grazed each other in the braided wires 8 for braiding. Accordingly, it is preferable that the high tension member 11 is composed of a single fiber.

An outer diameter of the high tension member 11 is preferably 0.05 mm to 0.10 mm. When the outer diameter of the high tension member 11 is less than 0.05 mm, a rigidity of the high tension member 11 is low, so that an expansion and contraction elasticity of the braid sleeve 4 is deteriorated. As a result, when the cable harness 1 is bent, openings of mesh of the braid sleeve 4 are easily enlarged and a surface of the electric wire 2 is easily exposed to the outside, thereby causing breakage of the electric wire 2 or deteriorating the EMI characteristics. On the other hand, when the outer diameter of the high tension member 11 is greater than 0.10 mm, a thickness of the braid sleeve 4 is increased, so that an outer diameter of the cable harness 1 is increased. As a result, it is difficult for the cable harness 1 to bend or slide in the wiring space with a very small height.

Considering the resistance property against the operation involving the sliding or the like for the material of the wire 8 for braiding, it is preferable that the high tension member 11 comprises a strip-shaped PET (polyethylene terephthalate) or PEEK (polyetheretherketone) having a tensile strength of 700 MPa or more, and that the metal strip 12 comprises a strip-shaped copper alloy having a tensile strength of 700 MPa or more, e.g. a copper alloy strip of 99.3Cu-0.7Sn or 99.7Cu-0.3Sn. By forming the wire 8 for braiding from the aforementioned materials, it is possible to prevent the high tension member 11 or the metal strip 12 from breakage at a bending part of the cable harness 1, when the cable harness 1 is bent. Further, it is more preferable that the metal strip 12 comprises a metal strip having a substantially rectangular cross section, which is formed by carrying out a rolling process or drawing process on a linear-shaped copper alloy wire having a having a tensile strength of 700 MPa or more and a circular cross section. The metal strip 12 preferably comprises a copper alloy wire in which a tensile strength (σ₁) after carrying out the rolling process is greater than a tensile strength (σ₀) before carrying out the rolling process. In particular, a ratio of a difference between the tensile strength (σ₁) of the copper alloy wire after the rolling process and the tensile strength (σ₀) of the copper alloy wire before the rolling process with respect to the tensile strength (σ₀) of the copper alloy wire before the rolling process (a ratio of increase in tensile strength due to processing=100×(σ₁−σ₀)/σ₀) is preferably 0% or more and 50% or less (0%≦100×(σ₁−σ₀)/σ₀≦50%),

In addition, the metal strip 12 preferably comprises a copper alloy wire in which a break elongation (δ₁) after carrying out the rolling process is greater than a break elongation (δ₀) before carrying out the rolling process. In particular, a ratio of a difference between the break elongation (δ₁) of the copper alloy wire after the rolling process and the break elongation (δ₀) of the copper alloy wire before the rolling process with respect to the break elongation (δ₀) of the copper alloy wire before the rolling process (a ratio of increase in break elongation due to processing=100×(δ₁−δ₀)/δ₀) is preferably 10% or more and 60% or less (10%≦100×(δ₁−δ₀)/δ₀≦60%), more preferably, 20% or more and 50% or less. It is possible to provide the braid sleeve 4 formed by braiding the wires 8 for braiding with a sufficient stiffness property (balance between hardness and softness) for following the slide operation, by using the metal strip 12 having the aforementioned tensile strength and break elongation. Therefore, even though the cable harness is installed in a very narrow wiring space, the cable harness can exhibit excellent slide operation-resistant properties effectively. Herein, the aforementioned tensile strength (σ) and break elongation (δ) of the copper alloy wire can be obtained by testing methods according to JIS standards (JIS Z 2241 “Method for tensile test for metallic materials”).

Further, a surface of the metal strip 12 is plated with Sn-plating, in order to suppress deterioration of shielding property due to oxidization of the metal strip 12. Further, a solder wettability of the metal strip 12 can be improved by the Sn-plating.

It is preferable that the metal strip 12 is spirally wound around the surface of the high tension member 11 by abutting wrapping such that adjacent side surfaces of the metal strip 12 are in contact with each other. According to this structure, it is possible to provide the surface of the metal strip 12 with a uniform (smooth) appearance with no level difference. Therefore, it is possible to reduce a grazing friction with a jacket (outer coating) of the electric wire 2 when the cable harness 1 slides while bending. According to this structure, it is possible to lengthen a lifetime of the metal strip 12 until the wire breakage when the cable harness 1 is installed in a narrow space. The cable harness 1 is sustainable for sliding operations for 200,000 times or more. In FIG. 3, the adjacent side surfaces of the metal strip 12 are illustrated as if they are separated from each other (namely, not in contact with each other). However, FIG. 3 is illustrated for the purpose of clarifying that the wire 8 for braiding comprises the high tension member 11 and the metal strip 12 wound around the high tension member 11. Therefore, the wrapping method is not limited thereto.

It is preferable that a thickness of the metal strip 12 is 0.005 mm or more and less than 0.013 mm. When the thickness of the metal strip 12 is less than 0.005 mm, a conductive resistance of the metal strip 12 is high, so that the EMI characteristics of the braid sleeve 4 at a low frequency (i.e. 100 MHz or less) is insufficient. Further, the metal strip 12 may be broken due to the grazing with a housing of the electronic device or the like. On the other hand, when the thickness of the metal strip 12 is 0.013 mm or more, the rigidity of the metal strip 12 is too high, so that it is difficult to wind the metal strip 12 around the high tension member 11. In addition, since the outer diameter of the wire 8 for braiding is increased, it is difficult for the cable harness 1 to bend or slide in the wiring space with a very small height.

An outer diameter of the wire 8 for braiding is preferably 0.13 mm or less. An outer diameter of the electric wire 2 is preferably 0.27 mm or less. In general, fifty threads of the electric wires (coaxial cables) 2 are used for the cable harness 1. Therefore, it is possible to install the cable harness 1 in the narrow wiring space with a height less than 3.0 mm, by setting the outer diameter of the single electric wire 2 to be 0.27 mm or less and the outer diameter of a single wire 8 for braiding to be 0.13 mm or less, respectively.

### EFFECTS OF THE EMBODIMENT

It is possible to provide the cable harness 1 with high straight advancing property and flexibility by using braid sleeve 4 having a configuration as described above. Therefore, it is possible to prevent the wire breakage, even though the cable harness 1 repeatedly slides for 200,000 times or more in the wiring space with very little height.

Further, a total structure of the braid sleeve 4 has the expansion and contraction elasticity like a spring because of the high rigidity of the high tension member 1. Therefore, the openings of the mesh are hardly opened in the movable part which involves sliding, and the EMI characteristics of the cable harness 1 is hardly deteriorated. As a result, the EMI characteristics substantially equal to that of the convention device can be provided.

Still further, breakage of the jacket due to the grazing between the jacket and the metal strip 12 hardly occurs at the movable part in which the braid sleeve 4 and the jacket of the electric wire 2 directly contact with each other.

As described above, according to the embodiment of the present invention, the cable harness 1 comprises a cable main body comprising a wire group comprising a plurality of electric wires and a braid sleeve collectively covering an outer periphery of the wire group, and connecting terminals connected to both ends of the cable main body, in which the braid sleeve is formed by braiding wires for braiding, and each of the wires for braiding comprises a high tension member having an indentation recovery coefficient of 90% or more and a metal strip wound around a surface of the high tension member.

According to this structure, it is possible to provide a cable harness which can be installed in a very narrow wiring space and which can carry out sliding operations for 200,000 times or more.

### EXAMPLES

Next, Examples of the embodiment according to the present invention will be explained below. Sliding property of cable harnesses in Examples 1 and 2 and a comparative example 1 were evaluated according to following method.

Samples of Examples 1 and 2 and the comparative example 1 were prepared as follows. As to an electric wire, a coaxial cable having a following configuration was used. A center conductor was a multi-strand wire comprising seven threads of Cu alloy wire having a wire diameter of 0.02 mm. An insulative coating (a thickness of 0.05 mm) made of PFA (perfluoro alkoxy copolymer) was formed around the center conductor. An outer conductor was formed by spirally wrapping Sn-plated Cu alloy wires (wire outer diameter of 0.25 mm and a tensile strength of 700 MPa) around an outer periphery of the insulative coating. A jacket made of PFA was formed around the outer conductor. An outer diameter of the coaxial cable was 0.27 mm.

As to a braid sleeve, a strip-shape high tension member (an outer diameter of 0.08 mm and a tensile strength of 800 MPa) made of PET having an indentation recovery coefficient as shown in TABLE 1 was prepared. A wire for braiding (an outer diameter of 0.104 mm) having indentation recovery coefficients shown in TABLE 1 was formed by wrapping a metal strip (thickness of 0.012 mm) made of Sn-plated Cu alloy (99.7Cu-0.3Sn and a tensile strength (σ₀) of 800 MPa, tensile strength (σ₁) of 840 MPa, break elongation (δ₀) of 1.08%, break elongation (δ₁) of 1.44%) around an outer periphery of the high tension member by abutting wrapping. The metal strip was formed to have a substantially rectangular cross section by rolling a copper alloy wire having a circular cross section (an outer diameter of 0.05 mm), prior to wrapping. A braid sleeve was formed by braiding a plurality of wires for braiding alternately to cross each other.

### (Slide Test)

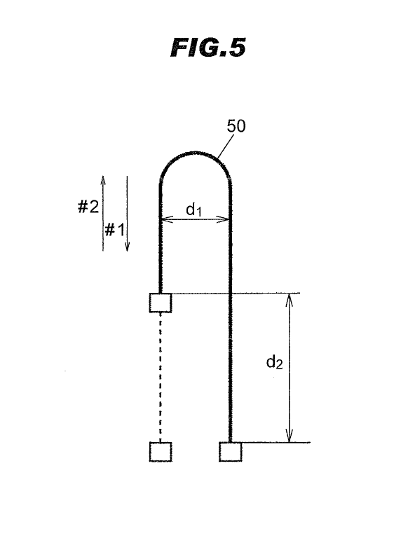

FIG. 5 is an explanatory diagram showing a slide test method.

First, a sample with an outer diameter of about 1.5 mm in which the electric wire (coaxial cable) is inserted into the braid sleeve was manufactured. Thereafter, the sample was installed in a wiring space with a height of about 2.0 mm.

In the flex text, as shown in FIG. 5, one end of a sample cable 50 was fixed, and another end of the sample cable 50 was bent such that a slide inner width (d1) is 15 mm. U-shape sliding operation was carried with a stroke length (d2) of 60 mm. A combination of a movement indicated by an arrow #1 and a movement indicated by an arrow #2 is defined as 1 cycle (1 time). U-shape sliding operation of the sample cable 50 was repeatedly carried out.

The test speed (the number of cycles per unit time) was 30 cycles/minute. Further, a voltage of several volts (V) was constantly applied to the sample cable 50 until electric current value drops by 20% from an initial value of the test. The time when the electric current value drops by 20% is considered as “lifetime”. The number of cycles in which the sample cable 50 reaches the lifetime was measured. TABLE 1 shows a measurement result.

TABLE 1

| | | | Comparative |
|---|---|---|---|
| | Example 1 | Example 2 | example 1 |
| Indentation recovery | 90% | 95% | 85% |
| coefficient of | | | |
| high tension member | | | |
| Indentation recovery | 80% | 85% | 75% |
| coefficient of | | | |
| wire for braiding | | | |
| Height of wiring space | 2.0 mm | 2.0 mm | 2.0 mm |
| Sliding characteristics | ∘ | ∘ | x |

In the sliding lifetime, “200,000 cycles and more” was evaluated as “∘: acceptable” and “less than 200,000 cycles” was evaluated “x: unacceptable”.

As shown in TABLE 1, the number of sliding cycles was 200,000 cycles or more in Examples 1 and 2 in which the indentation recovery coefficient of the high tension member was 90% or more.

On the other hand, the number of sliding cycles was much less than 200,000 cycles in the comparative example 1 in which the indentation recovery coefficient of the high tension member was 85%, namely less than 90%.

Accordingly, it is preferable that the indentation recovery coefficient of the high tension member is 90% or more.

As described above, according to the present invention, the cable harness comprises a cable main body comprising a wire group comprising a plurality of electric wires and a braid sleeve collectively covering an outer periphery of the wire group, and connecting terminals connected to both ends of the cable main body, in which the braid sleeve is formed by braiding wires for braiding, and each of the wires for braiding comprises a high tension member having an indentation recovery coefficient of 90% or more and a metal strip wound around a surface of the high tension member.

According to this structure, it is possible to provide a cable harness which can be installed in a very narrow wiring space and which has an excellent resistance property against the operation involving sliding.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A cable harness comprising:
a cable main body comprising a wire group comprising a plurality of electric wires and a braid sleeve collectively covering an outer periphery of the wire group, the braid sleeve comprising braided wires, each of the wires comprising a high tension member having an indentation recovery coefficient of 90% or more and a metal strip wound around a surface of the high tension member; and
connecting terminals connected to both ends of the cable main body.

2. The cable harness according to claim 1, wherein the wire has an indentation recovery coefficient of 80% or more.

3. The cable harness according to claim 1, wherein the metal strip is spirally wound around the surface of the high tension member by abutting wrapping.

4. The cable harness according to claim 2, wherein the metal strip is spirally wound around the surface of the high tension member by abutting wrapping.

5. The cable harness according to claim 1, wherein the high tension member comprises a PET having a tensile strength of 700 MPa or more and the metal strip comprises a copper alloy having a tensile strength of 700 MPa or more.

6. The cable harness according to claim 2, wherein the high tension member comprises a PET having a tensile strength of 700 MPa or more and the metal strip comprises a copper alloy having a tensile strength of 700 MPa or more.

7. The cable harness according to claim 3, wherein the high tension member comprises a PET having a tensile strength of 700 MPa or more and the metal strip comprises a copper alloy having a tensile strength of 700 MPa or more.

8. The cable harness according to claim 4, wherein the high tension member comprises a PET having a tensile strength of 700 MPa or more and the metal strip comprises a copper alloy having a tensile strength of 700 MPa or more.

9. The cable harness according to claim 1, wherein a surface of the metal strip is plated with Sn-plating.

10. The cable harness according to claim 1, wherein the high tension member comprises a single fiber.

11. The cable harness according to claim 1, wherein the metal strip comprises a copper alloy strip formed by rolling or drawing a linear-shaped copper alloy wire.

12. The cable harness according to claim 11, wherein the metal strip comprises the copper alloy strip having a first tensile strength after the rolling being greater than a second tensile strength before the rolling.

13. The cable harness according to claim 11, wherein the metal strip comprises the copper alloy strip having a first break elongation after the rolling being greater than a second break elongation before the rolling.

14. The cable harness according to claim 11, wherein a ratio of a difference between the first break elongation and the second break elongation with respect to the second break elongation is 10% or more and 60% or less.

15. The cable harness according to claim 1, wherein the indentation recovery coefficient of the high tension member is defined as a ratio of an indentation recovery length to an initial length when an indentation for an indentation length is carried out, where the initial length is a distance between a fixed end and a movable end of the high tension member before indentation, the indentation length is a predetermined value, and the indentation recovery length is a distance between the fixed end and the movable end after release of the indentation.
